(19) United States
(12) Patent Application Publication
(10) Pub. No.: US 2006/0176301 A1
(43) Pub. Date: Aug. 10, 2006

(54) Apparatus and method of creating 3D shape and computer-readable recording medium storing computer program for executing the method

(75) Inventors: Kyungah Sohn, Seoul (KR); Haibing Ren, Beijing (CN); Seokcheol Kee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/325,443

(22) Filed: Jan. 5, 2006

(30) Foreign Application Priority Data
Feb. 7, 2005 (KR) 2005-0011411

(51) Int. Cl. G06T 17/20

(52) U.S. Cl. 345/423

(57) ABSTRACT

An apparatus and a method of creating a three-dimensional (3D) shape, and a computer-readable recording medium storing a computer program for executing the method. The apparatus includes: a factor value setting unit setting factor values including a weight, a mapping factor, and a focal distance, for each of a plurality of stored 3D models; an error value calculating unit calculating an error value as a function of the factor value, the error value including a value of an extent of a difference between a first estimated shape and a second estimated shape; a control unit comparing the calculated error value with a preset reference value and outputting the result of comparison as a control signal; and a mapping unit weighing target weights to the stored three-dimensional models in response to the control signal, adding the stored 3D models having the weighed target weights, and creating a 3D shape of a given two-dimensional (2D) image. The apparatus can accurately estimate the 3D shape of the given 2D image using only the 2D image.

### CROSS-REFERENCE TO RELATED APPLICATION

This application claims the priority of Korean Patent Application No. 10-2005-0011411, filed on Feb. 7, 2005, in the Korean Intellectual Property Office, the disclosure of which is incorporated herein by reference.

### BACKGROUND OF THE INVENTION

1. Field of the Invention

The present invention relates to an apparatus and method of creating a three-dimensional (3D) shape by determining a combination of 3D models that can minimize the difference between a 3D shape estimated using a perspective projection model and a 3D shape created by combining stored 3D models and that can minimize the extent to which the created 3D shape deviates from a predetermined model.

2. Description of Related Art

A technology for estimating a three-dimensional (3D) shape of a given two-dimensional (2D) image is crucial to processing and interpreting the 2D image. The 2D image can be an image of a human face, and the 3D shape can be a shape of the human face.

Such a 3D shape estimating technology is used for 3D face shape modeling, face recognition, and image processing. Generally, an algorithm for estimating a 3D shape of a given 2D face image includes image capturing, face region detecting, face shape modeling, and face texture mapping.

Briefly, the algorithm proceeds as follows. After an image is captured, a face region is detected from the captured image. Then, the detected face image is mapped into a modeled face shape and a texture is formed on the modeled face shape.

U.S. Pat. No. 6,556,196 entitled “Method and Apparatus for the Processing of Images” discloses a conventional apparatus for estimating 3D shapes more precisely from a larger number of 2D images. Therefore, the apparatus cannot estimate a 3D shape precisely when only one 2D image is given and the estimation process is time-consuming.

To solve this problem, another conventional apparatus for estimating 3D shapes is disclosed in U.S. Pat. No. 6,492,986 entitled “Method for Human Face Shape and Motion Estimation Based on Integrating Optical Flow and Deformable Models.” This apparatus can estimate a 3D shape precisely even when only one 2D image is given but the estimation time is still long.

Another conventional apparatus for estimating 3D shapes is disclosed in the paper “Statistical Approach to Shape from Shading: Reconstruction of 3D Face Surfaces from Single 2D Images” published in 1996 by Joseph J. Atick of Rockefeller University, U.S. However, this apparatus too cannot solve the problems of the apparatus disclosed in U.S. Pat. No. 6,492,986.

In addition, the conventional apparatuses for estimating 3D shapes described above cannot estimate precisely a 3D shape of a given 2D image when active shape model (ASM) feature points of the 2D image are not accurately detected.

### BRIEF SUMMARY

An aspect of the present invention provides an apparatus for creating a three-dimensional (3D) shape by determining a combination of 3D models that can minimize the difference between a 3D shape estimated using a perspective projection model and a 3D shape created by combining stored 3D models and that can minimize the extent to which the created 3D shape deviates from a predetermined model.

An aspect of the present invention also provides a method of creating a 3D shape by determining a combination of 3D models that can minimize the difference between a 3D shape estimated using a perspective projection model and a 3D shape created by combining stored 3D models and that can minimize the extent to which the created 3D shape deviates from a predetermined model.

An aspect of the present invention also provides a computer-readable recording medium storing a computer program for executing a method of creating a 3D shape by determining a combination of 3D models that can minimize the difference between a 3D shape estimated using a perspective projection model and a 3D shape created by combining stored 3D models and that can minimize the extent to which the created 3D shape deviates from a predetermined model.

According to an aspect of the present invention, there is provided an apparatus for creating a three-dimensional shape, including: a factor value setting unit setting factor values including a weight, a mapping factor, and a focal distance, for each of a plurality of three-dimensional models stored in advance; an error value calculating unit calculating an error value as a function of the factor value wherein the error value comprises a value of an extent of a difference between a first estimated shape and a second estimated shape; a control unit comparing the calculated error value with a preset reference value and outputting the result of comparison as a control signal; and a mapping unit weighing target weights to the stored three-dimensional models in response to the control signal, adding the stored three-dimensional models having the weighed target weights, and creating a three-dimensional shape of a given two-dimensional image, wherein the mapping factor maps a two-dimensional variable to a three-dimensional variable, the first estimated shape is created by adding the stored three-dimensional models having set weights, the second estimated shape is created by mapping the two-dimensional image using the mapping factor, and the target weight is a weight having the calculated error value smaller than the preset reference value, among the set weights.

The error value may further include a value of an extent to which the first estimated shape deviates from a predetermined three-dimensional model.

The error value may further include a value of an extent to which the first estimated shape deviates from an average shape of the stored three-dimensional models.

The first estimated shape may be created by adding a shape created by adding the stored three-dimensional models having the set weights and the average shape of the stored three-dimensional models, the error value may further include a value proportional to a total sum of the set weights, and the mapping unit may weigh the target weights to the stored three-dimensional models in response to the control signal, add the stored three-dimensional models having the weighed target weights and the average shape of the stored three-dimensional models, and create the three-dimensional shape of the given two-dimensional image.

The control unit may instruct the factor value setting unit to reoperate if the calculated error value is greater than the preset reference value.

The factor value setting unit may set the factor value greater than a previous factor value by a first predetermined value, set the factor value greater than the previous factor value by a second predetermined value when receiving an instruction from the control unit to reoperate, and the first predetermined value may be greater than the second predetermined value.

The apparatus may further include a basic model storage unit storing the three-dimensional models.

The apparatus may further include a user interface unit providing an interface by which the factor value can be inputted and transmitting the input factor value to the factor value setting unit.

The given two-dimensional image may be generated by photographing, and the second estimated shape may be calculated by
Xₒᵢ^{t}=−(xᵢ₋Δx^{t-1})(Zₒᵢ^{t-1}−T_{z}^{t-1})/f^{t-1}+Tₓ^{t-1} (1)
Yₒᵢ^{t}=−(yᵢ₋Δy^{t-1})(Zₒᵢ^{t-1}−T_{z}^{t-1})/f^{t-1}+T_{y}^{t-1} (2)
Zₒᵢ^{t}=Zₒᵢ^{t-1} (3),
where o denotes the second estimated shape, x and y denote two-dimensional position information of each portion of the given two-dimensional image, i denotes a unique number of the each portion having the two-dimensional position information or a unique number of each of mapped portions of the second estimate shape, X, Y and Z denote three-dimensional position information of each portion of the second estimated shape, Tₓ, T_{y} or T_{z} is one of mapping factors and variable constant, Δx and Δy are factors that change position information of the given two-dimensional image, f, which is one of mapping factors, denotes a focal distance of a photographing device that obtains the given two-dimensional image, t denotes a factor t-th set by the factor value setting unit if t is used as a subscript of the factor, and t denotes the second estimated shape created using the t-th set factor if t is used as a subscript of the three-dimensional position information.

A number of the stored three-dimensional models may be n, and the first estimated shape may be calculated by

$$\begin{matrix}{X}_{e}^{t} = {X}_{avg} + {\sum }_{j = 1}^{n} {α}_{j} {σ}_{j} {X}_{j} , & ( 4 ) \\ {Y}_{e}^{t} = {Y}_{avg} + {\sum }_{j = 1}^{n} {α}_{j} {σ}_{j} {Y}_{j} , & ( 5 ) \\ {Z}_{e}^{t} = {Z}_{avg} + {\sum }_{j = 1}^{n} {α}_{j} {σ}_{j} {Z}_{j} , & ( 6 )\end{matrix}$$

where e denotes the first estimated shape, X, Y and Z denote three-dimensional position information of each portion of the first estimated shape, X_{avg}, Y_{avg} and Z_{avg} denote position information of each portion of the average shape of the n stored three-dimensional models, t denotes the first estimated shape created using a weight t-th set by the factor value setting unit, j denotes a unique number of each of the n stored three-dimensional models, α denotes the weight, Xⱼ, Yⱼ and Zⱼ denote three-dimensional position information of each portion of each of the n stored three-dimensional models, and σ is a variable constant and set for each of the n stored three-dimensional models.

The error value may be calculated by

$$\begin{matrix}F = {E}_{o} + {E}_{c} , & ( 7 ) \\ {E}_{O} = {E}_{d} / {s}^{2} , & ( 8 ) \\ {E}_{d} = {\sum }_{j = 1}^{n} ( {\sum }_{i = 1}^{m} {( {X}_{oi}^{t} - {X}_{ei}^{t} )}^{2} + {\sum }_{i = 1}^{m} {( {Y}_{oi}^{t} - {Y}_{ei}^{t} )}^{2} + {\sum }_{i = 1}^{m} {( {Z}_{oi}^{t} - {Z}_{ei}^{t} )}^{2} ) , & ( 9 ) \\ s = {P}_{o} / {P}_{avg} , & ( 10 ) \\ {E}_{c} = λ {\sum }_{j = 1}^{n} {α}_{j}^{2} , & ( 11 )\end{matrix}$$

where F denotes the error value calculated by the error value calculating unit, Eₒ denotes a value of an extent of a difference between the first estimated shape and the second estimated shape, E_{c} denotes the value of the extent to which the first estimated shape deviates from the average shape of the n stored three-dimensional models, e denotes the first estimated shape, o denotes the second estimated shape, oi denotes the unique number of each of the mapped portions of the second estimated shape, ei denotes a unique number of a portion of the first estimated shape having relative position information in the first estimated shape, which is identical to the relative position information, in the second estimated shape, of a portion of the second estimated shape having oi, m denotes a number of i, j denotes the unique number of each of the n stored three-dimensional models, Xₒ, Yₒ and Zₒ denote the three-dimensional position information of each portion of the second estimated shape, Xₑ, Yₑ and Zₑ denote the three-dimensional position information of each portion of the first estimated shape, which corresponds to the position information of each of Xₒ, Yₒ and Zₒ, s denotes a scale factor, Pₒ denotes a size of an image of the second estimated shape projected onto a predetermined surface, P_{avg} denotes a size of an image of the average shape of the n stored three-dimensional models projected onto the predetermined surface, α denotes the weight, and λ is a proportional factor set in advance.

According to another aspect of the present invention, there is provided a method of creating a three-dimensional shape, including: setting a factor value, which comprises a weight, a mapping factor, and a focal distance, for each of a plurality of three-dimensional models stored in advance; calculating an error value as a function of the factor value wherein the error value includes a value of an extent of a difference between a first estimated shape and a second estimated shape, according to the factor value; comparing the calculated error value with a preset reference value; and weighing the set weight to the stored three-dimensional model if the calculated error value is smaller than the preset reference value, adding the weighted three-dimensional models, and creating a three-dimensional shape of a given two-dimensional image, wherein the mapping factor maps a two-dimensional variable to a three-dimensional variable, the first estimated shape is created by adding the weighted three-dimensional models, and the second estimated shape is created by mapping the two-dimensional image using the mapping factor.

The error value may further include a value of an extent to which the first estimated shape deviates from a predetermined three-dimensional model.

The method may further include changing the factor value to an initial set value set in advance and initializing the factor value.

The calculating of the error value may include: calculating the error value, which is the function of the factor value and comprises the value of the extent to which the first estimated shape deviates from the second estimated shape, according to the set factor value; determining whether the error value was calculated for the first time; and performing the setting of the factor value if it is determined that the error value was calculated for the first time.

The comparing of the calculated error value with the preset reference value may include comparing the calculated error value with a previously calculated error value and comparing the calculated error value with a preset reference value if the calculated error value is smaller than the previously calculated error value, and in the creating of the three-dimensional shape of the given two-dimensional image, target weights may be weighted to the stored three-dimensional models if the calculated error value is smaller than the preset reference value, the weighted three-dimensional models may be added, and the three-dimensional shape of the given two-dimensional image may be created, and the target weights may be weight having the calculated error value smaller than the preset reference value, among the set weights.

The comparing of the calculated error value with the preset reference value may include comparing the calculated error value with the previously calculated error value if the error value was not calculated for the first time and comparing the calculated error value with the preset reference value if the calculated error value is smaller than the previously calculated error value, and in the creating of the three-dimensional shape of the given two-dimensional image, the target weights may be weighted to the stored three-dimensional models if the calculated error value is smaller than the preset reference value, the weighted three-dimensional models may be added, and the three-dimensional shape of the given two-dimensional image may be created, and the target weight may be a weight having the calculated error value smaller than the preset reference value, among the set weights.

The comparing of the calculated error value with the preset reference value may include comparing the calculated error value with the previously calculated error value and performing the setting of the factor value if the calculated error value is greater than the previously calculated error value.

The method may further include performing the setting of the factor value if the calculated error value is greater than the preset reference value.

According to another aspect of the present invention, there is provided a computer-readable recording medium storing a computer program for executing a method of creating a three-dimensional shape, the method including: setting a factor value, which comprises a weight, a mapping factor, and a focal distance, for each of a plurality of three-dimensional models stored in advance; calculating an error value as a function of the factor value wherein the error value includes a value of an extent of a difference between a first estimated shape and a second estimated shape, according to the factor value; comparing the calculated error value with a preset reference value; and weighing the set weight to the stored three-dimensional model if the calculated error value is smaller than the preset reference value, adding the weighted three-dimensional models, and creating a three-dimensional shape of a given two-dimensional image, wherein the mapping factor maps a two-dimensional variable to a three-dimensional variable, the first estimated shape is created by adding the weighted three-dimensional models, and the second estimated shape is created by mapping the two-dimensional image using the mapping factor.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1A and 1B are reference diagrams for explaining the relationship between a two-dimensional (2D) image and a three-dimensional (3D) shape thereof;

FIG. 2 is a block diagram of an apparatus for creating a 3D shape according to an embodiment of the present invention;

FIG. 3 is a reference diagram for illustrating feature points detected from a given 2D image;

FIGS. 4A-4C are reference diagrams for explaining a method of setting a factor value using a factor value setting unit of FIG. 2 according to an embodiment of the present invention;

FIGS. 5A through 12C are reference diagrams for explaining the effects of embodiments of the present invention; and

FIG. 13 is a flowchart illustrating a method of creating a 3D shape according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

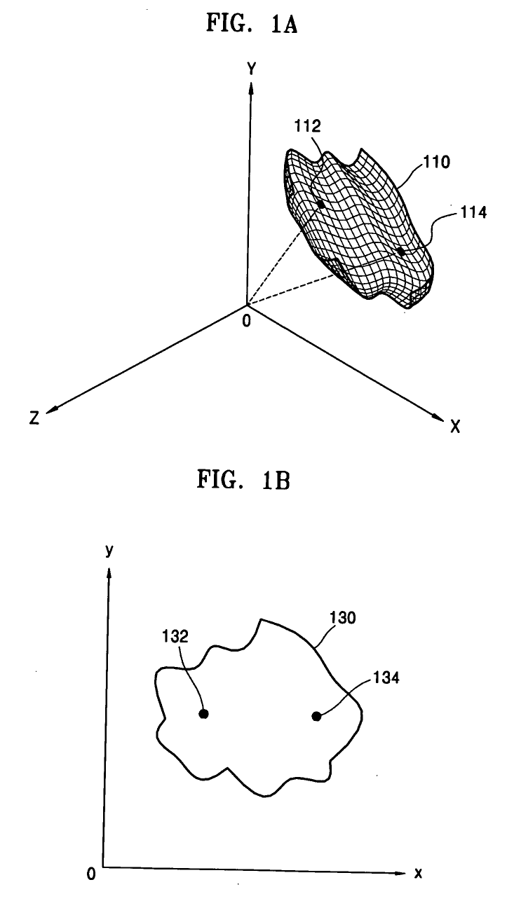

FIGS. 1A and 1B are reference diagrams for explaining the relationship between a two-dimensional (2D) image and a three-dimensional (3D) shape thereof. Referring to FIGS. 1A and 1B, an image pick-up device (not shown) such as a camera is placed on the Z axis and used to acquire a 2D image 130 of a 3D object 110.

The image pick-up device (not shown) photographs the 3D object 110 and acquires the 2D image 130. An apparatus and method of creating a given 3D shape, and a computer-readable recording medium storing a computer program for executing the method according to embodiments of the present invention provides a technology that creates a 3D shape of the 2D image 130 when the 2D image 130 is given. In FIG. 1, the 3D shape denotes a shape of the 3D object 110. Ultimately, embodiments of the present invention suggests a technology for mapping 2D position information indicated by reference numerals 132 and 134 in the 2D image 130 are mapped to 3D position information indicated by reference numerals 112 and 114 on the 3D object 110.

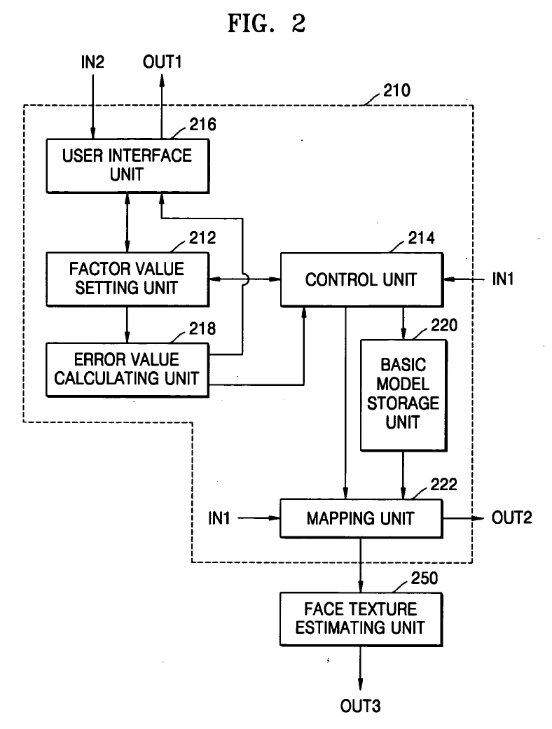

FIG. 2 is a block diagram of an apparatus 210 for creating a 3D shape according to an embodiment of the present invention. The apparatus 210 includes a factor value setting unit 212, a control unit 214, a user interface unit 216, an error value calculating unit 218, a basic model storage unit 220, and a mapping unit 222. The apparatus 210 may also be referred to as a face shape estimating device.

The factor value setting unit 212 sets factor values, which include a weight, a mapping factor value, and a focal distance, for each of a plurality of 3D models stored in advance stored in the basic model storage unit 220, for example.

The factor value setting unit 212 may operate under the control of the control unit 214 connected thereto. Factors set by the factor value setting unit 212 include a weight, a mapping factor, and focal distance. The apparatus 210 weights a weight to each of the 3D models stored in advance, adds the weighted 3D models, and creates a 3D shape. Weighting of a weight may denote a multiplication operation. The 3D models that are weighed larger weights have greater importance in the 3D shape to be created.

To create an accurate 3D shape, a weight set by the factor value setting unit 212 must satisfy a predetermined condition. Hereinafter, a weight that satisfies the predetermined condition will be called a target weight. The predetermined condition will be described later, together with operations of the error value calculating unit 218 and the control unit 214.

The factor value setting unit 212 may also set a weight and a mapping factor when setting a factor value.

A mapping factor set by the factor value setting unit 212 maps a 2D variable such as (x, y) to a 3D variable such as (X, Y, Z). For example, it may be assumed that a mapping factor is (Tₓ, T_{y}, T_{z}). In this case, 2D position information (x, y) is mapped to 3D position information (X, Y, Z) using the mapping factor (Tₓ, T_{y}, T_{z}). Tₓ, T_{y}, and T_{z} are constants set by a user and may be variable.

The mapping factor may also include a focal length f in addition to Tₓ, T_{y}, and T_{z} described above. “f,” which is one of factors set by the factor value setting unit 212 denotes a focal length set in the image pick-up device (not shown) when a 2D image is picked up and created by the image pick-up device.

The factor value setting unit 212 may set a factor value randomly or according to a predetermined rule. The factor value setting unit 212 may set a value received from the user interface unit 216 as a factor value. IN2 indicates a value received from the user interface unit 216.

The control unit 214 may instruct the factor value setting unit 212 to operate when a 2D image is given.

The user interface unit 216 provides a predetermined interface (not shown). More specifically, if the factor value setting unit 212 sets a factor value by bypassing a value received from the user interface unit 216, the factor value setting unit 212 instructs the user interface unit 216 to provide a predetermined interface. The predetermined interface denotes an interface through which a user can input the value. OUT 1 indicates an interface that the user interface unit 216 provides.

The error value calculating unit receives a factor value from the factor value setting unit 212 and calculates an error value according to the received factor value. Hereinafter, an error value calculated by the error value calculating unit 218 will be called F. F is function of factor value and can be expressed as
F=Eₒ+E_{c} (1),
where Eₒ denotes observation energy and E_{c} denotes shape constraint energy. The observation energy is a difference value between a first estimated shape and a second estimated shape.

The first estimated shape is created by adding models to which a weight set by the factor value setting unit 212 is assigned. The second estimated shape is a mapped shape of a 2D image given to the present apparatus 210 using a mapping factor. In other words, both of the first and second estimated shapes are 3D shapes. In the meantime, Eₒ can be given by
E_{O}=E_{d}/s² (2),
where E_{d} indicates the difference between 3D position information of each portion of the first estimated shape corresponding to each portion of a given 2D image IN1 and 3D position information of each portion of the second estimated shape. In other words, the difference between the first estimated shape and the second estimated shape may be obtained by comparing position information of their portions having the same phase in three dimensions.

If a phase of a portion of the first estimated shape is the same as that of a portion of the second estimated shape, the two portions correspond to the same portion of the given 2D image IN1.

For example, a portion of the first estimated shape corresponding to the pupil of the eye in a given 2D image is a pupil portion of the first estimated shape. Likewise, a portion of the second estimated shape is a pupil portion of the second estimated shape.

Each portion of the given 2D image IN1 may be a characteristic portion. If the given 2D image IN1 is an image of a human face, each portion of the given 2D image may be an eye, nose, eyebrow, or lip portion.

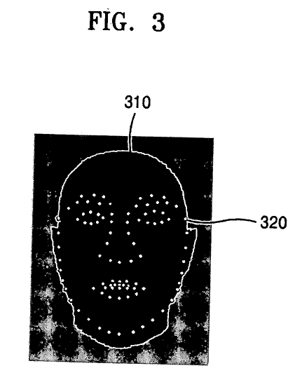

FIG. 3 is a reference diagram for illustrating feature points detected from a given 2D image 310. Referring to FIG. 3, predetermined portions of the 2D image 310 are expressed as points 320.

The points 320 may be called feature points. Such feature points may accurately express each portion of a face, such as eyes, a nose and lips. To this end, the feature points may be detected using an active shape model (ASM) algorithm, which is a widely known technology in the field of face recognition. That is, each portion of a given 2D image may be a feature point detected using the ASM algorithm.

When an elaborate ASM algorithm is used, detected feature points express eye, nose, and lip portions accurately. However, when a less elaborate ASM algorithm is used, the detected feature points may not accurately express each portion of the face. However, the present invention suggests a technology that accurately creates a 3D shape regardless of positions of feature points detected from a given 2D image using the ASM algorithm.

As described above, E_{d} indicates the difference between 3D position information of each portion of the first estimated shape corresponding to each portion of the given 2D image IN1 and 3D position information of each portion of the second estimated shape. Hereinafter, it is assumed that each portion of a given 2D image refers to each of m portions of the 2D image. The m portions of the 2D image may or may not be the points 320, i.e., feature points, described above.

3D position information of each portion (hereinafter, called selected portion) of the second estimated shape corresponding to each portion of a given 2D image (hereinafter, called a second comparison portion) denotes position information of a selected portion mapped by a mapping factor. In this case, the mapping factor is set by the factor value setting unit 212.

For example, position information (Xₒ, Yₒ, Zₒₓ) of the second comparison portion denotes position information of the selected portion having position information (x, y) and mapped by (Tₓ, T_{y}, T_{z}) and f. Here, o denotes the second estimated shape. More specifically, the position information of the second comparison portion can be calculated using the following equations. Theses equations are called an equation of a perspective projection model.
Xₒᵢ^{t}=−(xᵢ₋Δx^{t-1}(Zₒᵢ^{t-1}−T_{z}^{t-1})/ƒ^{t-1}+Tₓ^{t-1} (3)
Yₒᵢ^{t}=−(yᵢ₋Δy^{t-1})Zₒᵢ^{t-1}−T_{z}^{t-1})/ƒ^{t-1}+T_{y}^{t-1} (4)
Zₒᵢ^{t}=Zₒᵢ^{t-1} (5),
where o denotes the second estimated shape, x and y denote position information of the selected portion, and i has two meanings. When i is used as a subscript of x or y, i may denote a unique number of the selected portion. When i is used as a subscript of Xₒ, Yₒ or Zₒ, i may denote a portion (xᵢ, yᵢ) of the second estimated shape mapped by a mapping factor.

Xₒ, Yₒ, and Zₒ denote 3D position information of each portion of the second estimated shape. More specifically, Xₒ, Yₒ, and Zₒ may indicate the position information of the second comparison portion.

Tₓ, T_{y} and T_{z} are mapping factors and variable numerals. Δx and Δy are factors that change position information of a given 2D image. Also, f, one of mapping factors, denotes a focal distance of a pick-up device that picks up a given 2D image. In other words, factors set by the factor value setting unit 212 are Tₓ, T_{y}, T_{z}, f, Δx and Δy.

If t is used as a subscript of a factor, it denotes a t^{th} set factor by the factor value setting unit 212. If t is used as a subscript of 3D position information (X, Y, Z), it denotes the second estimated shape created using the t^{th} factor.

Equations 3 through 5 may be simplified into
Xₒᵢ^{t}=k₁(xᵢ+Tₓ^{t-1}) (6)
Yₒᵢ^{t}=k₂(yᵢT_{y}^{t-1}) (7),
Zₒᵢ^{t}=k₃ (8),
where k1, k2, and k3 are variable numerals. Equations 6 through 8 can be called as equations of a weak perspective projection model.

3D position information of each portion of the first estimated shape (hereinafter, called a first comparison portion) corresponding to the selected portion is created such that relative position information of the first comparison portion in the first estimated shape is identical to that of the second comparison portion in the second estimated shape.

For example, it is assumed that the second estimated shape is a face shape and the second comparison portion is a philtrum portion of the second estimated shape. It is also assumed that the second comparison portion is a groove between second and third protruded portions from the lowest end of the second estimated shape and is a deepest portion. In this case, the lowest end of the second estimated shape denotes a jaw, and the second protruded portion denotes an upper lip, and the third protruded portion denotes the tip of the nose. Ultimately, it is assumed that the second comparison portion is a part of the philtrum portion that meets the upper lip. The first comparison portion is a groove between second and third protruded portions from the lowest end of the first estimated shape and is a deepest portion.

The first estimated shape may be estimated using a principal component analysis (PCA) method. The PCA method assigns a predetermined weight to each of n basic 3D models, adds the n weighted models, and creates a 3D shape. The n basic 3D models may be stored in advance. The equations for creating the first estimated shape may be expressed as

$$\begin{matrix}{X}_{e}^{t} = {X}_{avg} + {\sum }_{j = 1}^{n} {α}_{j} {σ}_{j} {X}_{j} , & ( 9 ) \\ {Y}_{e}^{t} = {Y}_{avg} + {\sum }_{j = 1}^{n} {α}_{j} {σ}_{j} {Y}_{j} , & ( 10 ) \\ {Z}_{e}^{t} = {Z}_{avg} + {\sum }_{j = 1}^{n} {α}_{j} {σ}_{j} {Z}_{j} , & ( 11 )\end{matrix}$$

where e denotes the first estimated shape and Xₑ, Yₑ and Zₑ denote 3D position information of each portion of the first estimated shape. Each portion of the first estimated portion may be the first comparison portion.

X_{avg}, Y_{avg}, and Z_{avg} denote position information of each portion of an average shape of the n stored basic 3D models. More specifically, X_{avg}, Y_{avg}, and Z_{avg} may denote position information of the first comparison portion when the same weight is assign to each of the n stored basic 3D models.

t denotes the first estimated shape created using a t^{th} weight set by the factor value setting unit 212. j denotes a unique number of each of the n stored basic 3D models, and α| denotes a weight.

Xⱼ, Yⱼ and Zⱼ denote position information of a portion corresponding to the first comparison portion of the first estimated shape in a j^{th} stored basic 3D model. σ is a variable constant and is set for each of the n stored basic 3D models.

As described above, Eₒ=E_{d}/(sˆ2). Ed is the difference between the position information of the first comparison portion and the position information of the second comparison and is given by

$${E}_{d} = {\sum }_{j = 1}^{n} ( {\sum }_{i = 1}^{m} {( {X}_{oi}^{t} - {X}_{ei}^{t} )}^{2} + {\sum }_{i = 1}^{m} {( {Y}_{oi}^{t} - {Y}_{ei}^{t} )}^{2} + {\sum }_{i = 1}^{m} {( {Z}_{oi}^{t} - {Z}_{ei}^{t} )}^{2} ) , \qquad ( 12 )$$

where oi denotes a unique number of each second comparison portion. Since it is assumed that the number of i is m, the number of oi may also be m. Likewise, ei denotes a unique number of each first comparison portion, and since the number of i is m, the number of ei may also be m.

Since Eₒ is a value of the first estimated shape and the second estimated shape, Eₒ may not be affected by the size of the first estimated shape or the second estimated shape. In other words, Eₒ is calculated by comparing the “shape” of the first estimated shape and the second estimated shape without considering the “sizes” of the first estimated shape and the second estimated shape.

Eₒ may include a scale factor s, which may be given by
s=Pₒ/P_{avg} (13),
where Pₒ denotes the size of an image of the second estimated shape projected onto a predetermined surface. P_{avg} denotes the size of an image of an average shape of the n stored basic 3D models projected onto the predetermined surface. The predetermined surface is not variable.

As described above, an error value F calculated by the error value calculating unit 218 may include E_{c} as well as Eₒ. In this case, E_{c} may be a value of the extent to which the first estimated shape deviates from a predetermined model. The predetermined model may be or may not be an average shape of the n stored basic 3D models. Ec can be calculated using Equation 14, which may relate to a case where the predetermined model is the average shape of the n stored basic 3D models.

$${E}_{c} = λ {\sum }_{j = 1}^{n} {α}_{j}^{2} , \qquad ( 14 )$$

where λ is a proportional constant set in advance. More specifically, λ is a constant set by a user to determine the importance of each of Eₒ and E_{c} in F. If a user regards E_{c} as being more important than Eₒ, the user may set λ to a higher value.

If all λ values are zero (j=1˜n), the position information (Xₑ, Yₑ, Zₑ) of the first estimated shape becomes (X_{avg}, Y_{avg}, Z_{avg}) by Equations 9 through 11. Since all of the n stored basic 3D models have shapes of general human faces, a model having position information (X_{avg}, Y_{avg}, Z_{avg}) has a shape of a human face. Thus, if all values are zero, the first estimated shape may match an average shape of the n stored basic 3D models.

A smaller E_{c} value leads to a smaller F value, and the first estimated shape, which is estimated using such a λ value, is certainly closer to a shape of a human face.

The basic model storage unit 220 stores the n basic 3D models, preferably in advance. When the error value calculating unit 218 calculates the error value F, the control unit 214 compares the calculated error value with a reference value set in advance, and generates a control signal according to the result of the comparison. The reference value may vary.

Specifically, if the calculated error value is greater than the reference value, the control unit 214 generates a control signal instructing the factor value setting unit 212 to operate again. In this case, the error value calculating unit 218 also operates again, and the control unit 214 compares an error value recalculated according to a reset factor value with the reference value.

Conversely, if the calculated error value is smaller than the reference value, the control unit 214 instructs the mapping unit 222 to operate. In response to the control signal generated by the control unit 214, the mapping unit assigns n target weights to the n stored basic 3D models, respectively, adds the n stored basic 3D models with the n target weights, and creates a 3D shape of the given 2D image.

Here, the target weight denotes a set weight for which a calculated error value is smaller than the reference value. For the sake of explanation, the target weight may be defined as a t^{th} set weight. If the first estimated shape is defined by Equations 9 through 11 and E_{c} is defined by Equation 11, the mapping unit 222 assigns target weights to the n stored basic 3D models, adds the n stored basic 3D models with the target weights and an average shape of the n stored basic 3D models, and creates a 3D shape.

If the calculated error value is equal to the reference value, the control unit 214 may generate the control signal instructing the factor value setting unit 212 to reoperate or indicating the mapping unit 222 to operate. OUT2 indicates a generated 3D shape.

A method of creating a 3D shape according to the present invention has been described above. To this end, a face texture estimating unit 250 forms a predetermined texture on a 3D shape generated by the mapping unit 222. OUT3 indicates a textured 3D face shape.

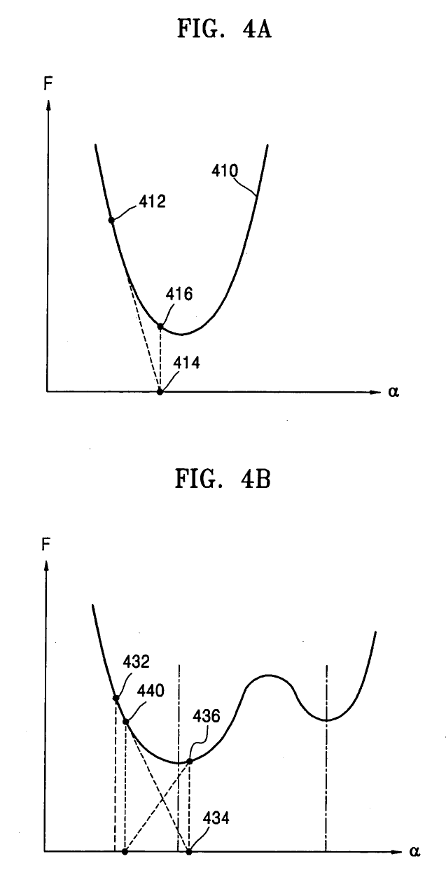

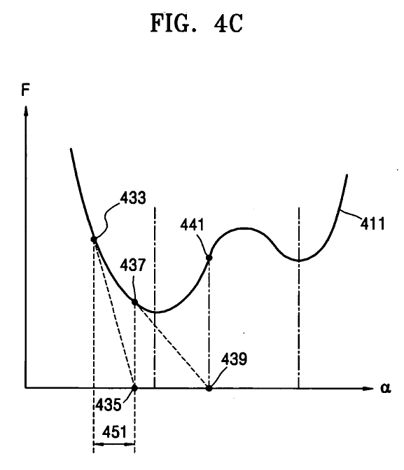

FIGS. 4A-4C are reference diagrams for explaining a method of setting a factor value using the factor value setting unit 212 of FIG. 2 according to an embodiment of the present invention. To quickly create a 3D shape using the present invention, the factor value setting unit 212 may quickly set a factor value.

The factor value setting unit 212 may set factor values that gradually reduce calculated error values. In other words, the factor value setting unit 212 sets a factor value greater than a previously set factor value by a first predetermined value. An error value calculated according to the currently set factor value may be smaller than an error value calculated according to the previously set factor value. To this end, the factor value setting unit 212 may set factor values using a Newton algorithm expressed as
T^{t}=T^{t-1}−step*∂F/∂T(α^{t-1},T^{t-1},ƒ^{t-1}) (15),
α^{t}α^{t-1}−step*∂F/∂α(α^{t-1},T^{t-1},ƒ^{t-1}) (16),
ƒ^{t}=ƒ^{t-1}−step*∂F/∂f(α^{t-1},T^{t-1},ƒ^{t-1}) (17),

Referring to FIGS. 4A and 4B, all horizontal axes denote α and all vertical axes denote F. Here, the horizontal axes may be α, T, or f. t denotes a t^{th} set factor value and t-1 denotes a (t-1)^{th} set factor value.

Equations 15 through 17 will now be described geometrically. Referring to FIG. 4A, it is assumed that the factor value setting unit 212 of FIG. 2 initially sets a factor value α corresponding to a point 412 on an error value graph 410. The factor value setting unit 212 may set a value corresponding to a point 414 as a next factor value α. In other words, using the Newton algorithm, the factor value setting unit 212 may set a value of the point 414, at which a tangent extending from the point 412 on the error value graph 410 meets the α axis, as the new α factor value. The new α factor value corresponds to a point indicated by reference numeral 416 on the error value graph 410. Since an F value indicated by reference numeral 416 is smaller than an F value indicated by reference numeral 412, the factor value setting unit 212 sets the factor value correctly by changing the α factor value indicated by reference numeral 412 to the α factor value indicated by reference numeral 416.

Even when the Newton algorithm is used, a factor value that increases the error value F may be set. Referring to FIG. 4B, if reference numeral 432 indicates a factor value set initially, a factor value set for the second time is indicated by reference numeral 434, and an error value corresponding to the factor value set for the second time is an F value indicated by reference numeral 436. After all, the error value calculated for the second time is smaller than the error value calculated for the first time. However, since an F value indicated by reference numeral 440 is greater than an F value indicated by reference numeral 436, an error value calculated for the third time is greater than the error value calculated for the second time. That is, even when the Newton algorithm is used, a factor value that increases the error value F may be set.

To solve this problem, if the factor value setting unit 212 of FIG. 2 receives an instruction to reoperate from the control unit 212, that is, if an error value calculated according to a currently set factor value is greater than an error value calculated according to its previously set factor value, the factor value setting unit 212 may set a factor value greater than the previously set factor value by a second predetermined value. The second predetermined value is a constant smaller than the first predetermined value.

If an error value calculated according to a currently set factor value is still greater than an error value calculated according to its previously set factor value, the factor value setting unit 212 may set a factor value greater than the previously set factor value by a third predetermined value. The third predetermined value is a constant smaller than the second predetermined value.

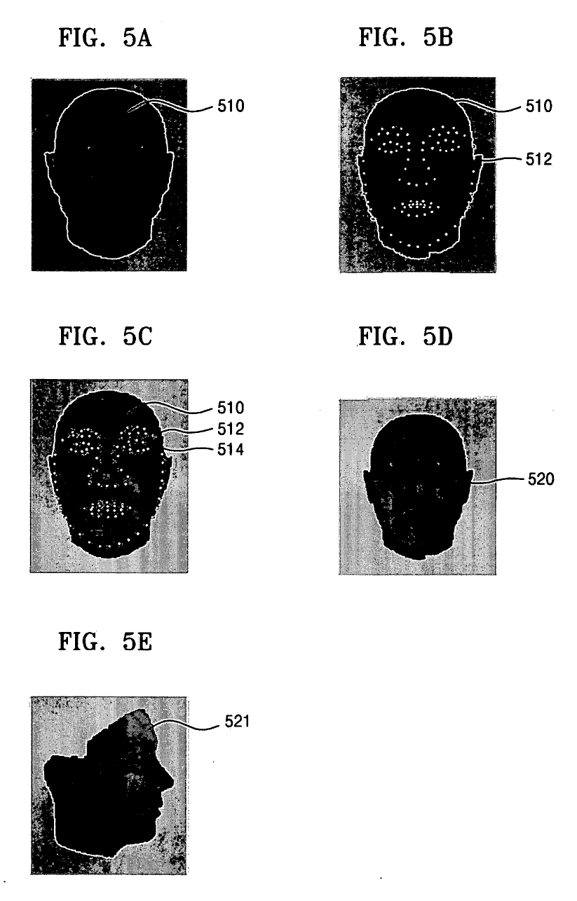

FIGS. 5 through 12 are reference diagrams for explaining the effects of an embodiment of the present invention. FIG. 5A shows an example of a given 2D image 510 and FIG. 5B shows an example of preferable feature points 512 that can be detected using the ASM algorithm. FIG. 5C shows an example of feature points 514 actually detected. Referring to FIGS. 5A through 5C, there is no such difference between the actually detected feature points 514 and the preferable feature points 512. In other words, the feature points 514 shown in FIG. 5C are detected using the elaborate ASM algorithm.

FIG. 5D shows a front 520 of a 3D shape created according to an embodiment of the present invention. FIG. 5E shows a side 521 of the 3D shape created according to an embodiment of the present invention. The face shapes shown in FIGS. 5D and 5E are very similar to the 2D image 510 of FIG. 5A.

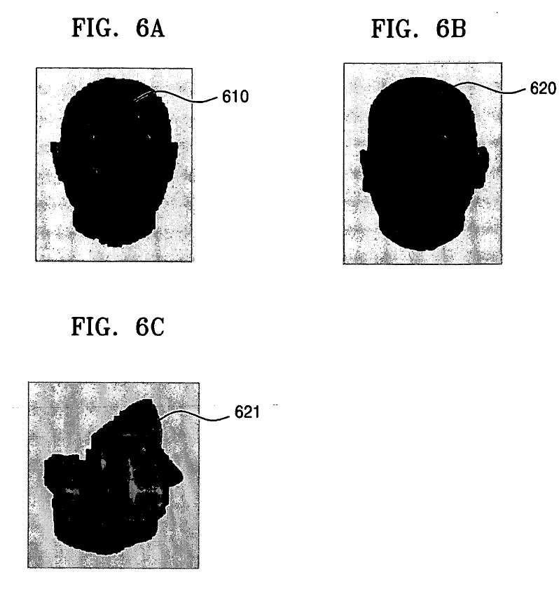

FIG. 6A shows a 2D image identical to the 2D image 510 of FIG. 5A. FIGS. 6B and 6C show a 3D shape created according to an embodiment of the present invention when E_{c} does not exist in the error value F calculated by the error value calculating unit 218. Specifically, FIG. 6B shows a front 620 of the 3D shape and FIG. 6C shows a side 621 of the 3D shape. The face shapes shown in FIGS. 6B and 6C are a little different from the 2D image 610 of FIG. 6A.

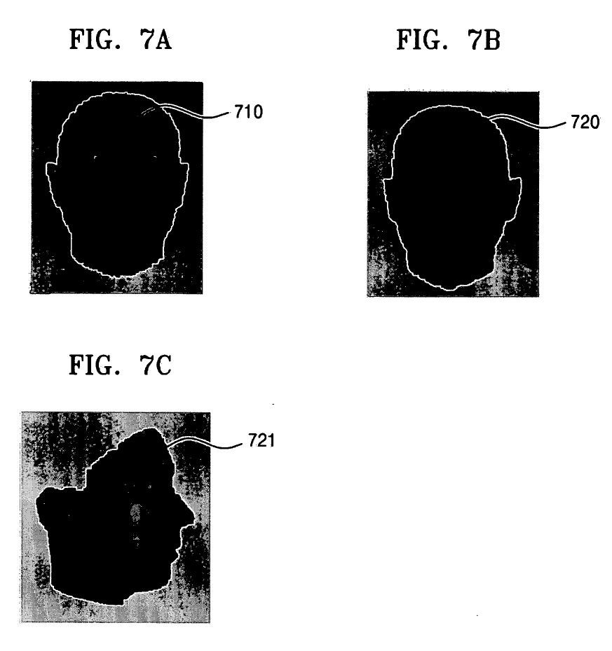

FIG. 7A shows a 2D image 710 identical to the 2D image 510 of FIG. 5A. FIGS. 7B and 7C show a 3D shape created according to an embodiment of the present invention when the second estimated shape is estimated using Equations 6 through 8, not 3 through 5. FIG. 7B shows a front 720 of the 3D shape and FIG. 7C shows a side 721 of the 3D shape. Since the face shapes of FIGS. 7B and 7C are slimmer than the 2D image 710 of FIG. 7A, the face shapes of FIGS. 7B and 7C are different from the 2D image 710 of FIG. 7A.

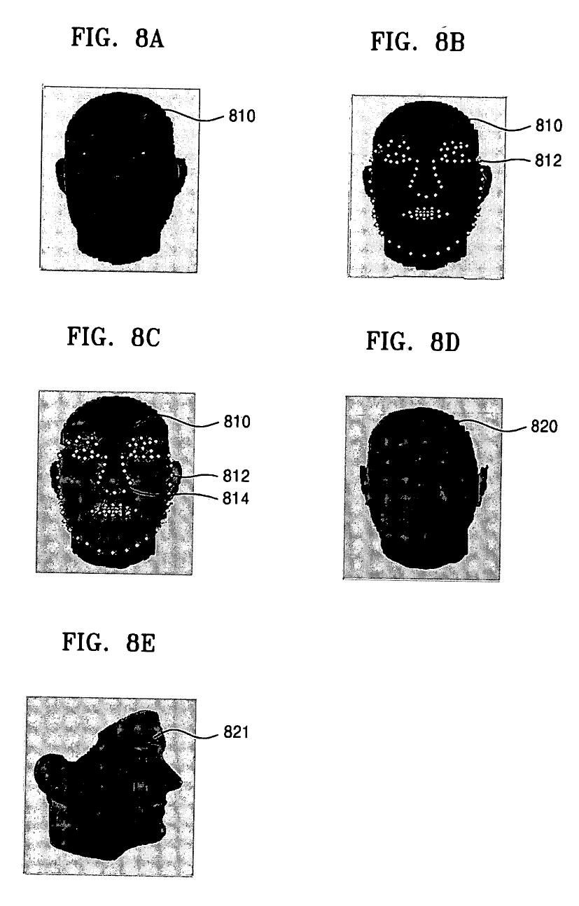

FIG. 8 shows an example of a given 2D image 810 and FIG. 8B shows an example of preferable feature points 812 that can be detected from the 2D image 810 using the ASM algorithm. FIG. 8C shows an example of feature points 814 actually detected. Referring to FIGS. 8A through 8C, there is a big difference between the actually detected feature points 814 and the preferable feature points 812. In other words, the feature points of FIG. 8C were detected using the less elaborate ASM algorithm.

FIG. 8D shows a front 820 of a 3D shape created according to the present invention. FIG. 8E shows a side 821 of the 3D shape created according to an embodiment of the present invention. The face shapes shown in FIGS. 8D and 8E are very similar to the 2D image 810 of FIG. 8A. In other words, even through the feature points 814 actually detected using the ASM algorithm are not preferable, an embodiment of the present invention creates the 3D shapes 820 and 821 that are very similar to the 2D image 810.

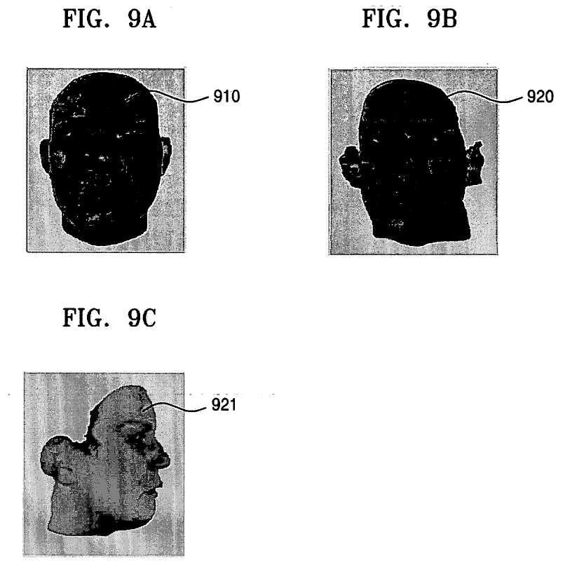

FIG. 9A shows a 2D image 910 identical to the 2D image 810 of FIG. 8A. FIGS. 9B and 9C show a 3D shape created according to an embodiment of the present invention when E_{c} does not exist in the error value F calculated by the error value calculating unit 218. Specifically, FIG. 9B shows a front 920 of the 3D shape and FIG. 9C shows a side 921 of the 3D shape. The face shapes shown in FIGS. 9B and 9C are very different from the 2D image 910 of FIG. 9A. In particular, ear portions of the face shape shown in FIG. 9B are very distorted and do not look like ears.

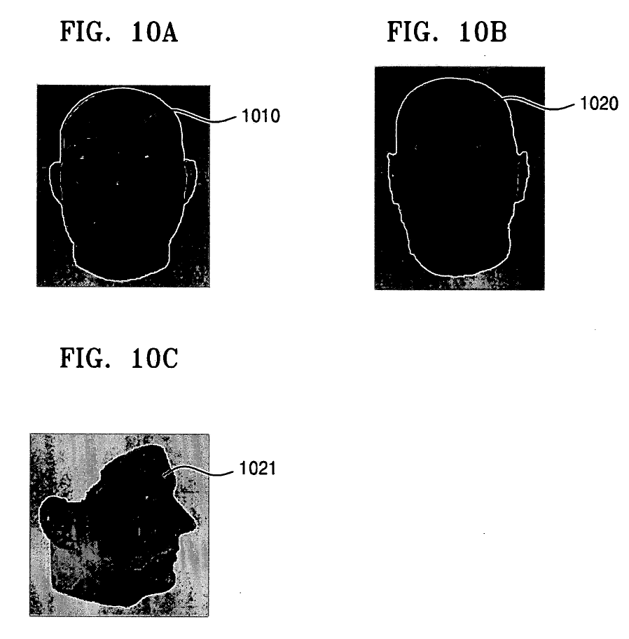

FIG. 10A shows a 2D image 1010 identical to the 2D image 810 of FIG. 8A. FIGS. 10B and 10C show a 3D shape created according to an embodiment of the present invention when the second estimated shape is estimated using Equations 6 through 8, not 3 through 5. FIG. 10B shows a front 1020 of the 3D shape and FIG. 10C shows a side 1021 of the 3D shape. Since the face shapes of FIGS. 7B and 7C are slimmer than the 2D image 1010 of FIG. 1A, the face shapes of FIGS. 10B and 10C are different from the 2D image 1010 of FIG. 10A.

Ultimately, an embodiment of the present invention accurately estimates a 3D shape by determining a combination of 3D models that can minimize the difference between a 3D shape estimated using the perspective projection model and a 3D shape created by combining stored 3D models and that can minimize the extent to which the created 3D shape deviates from a predetermined model.

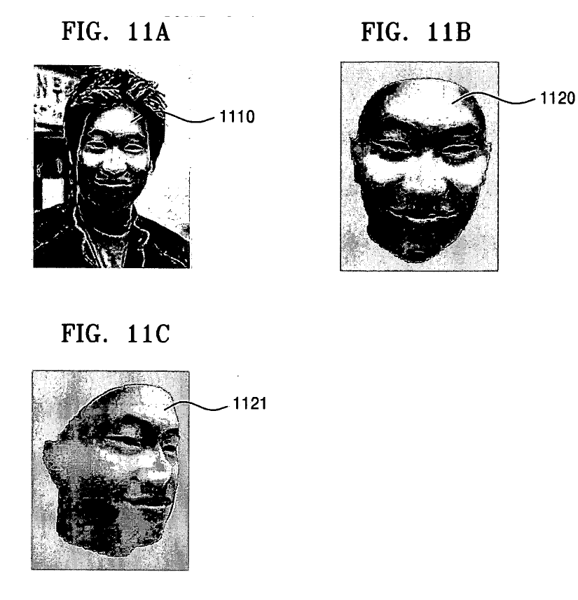

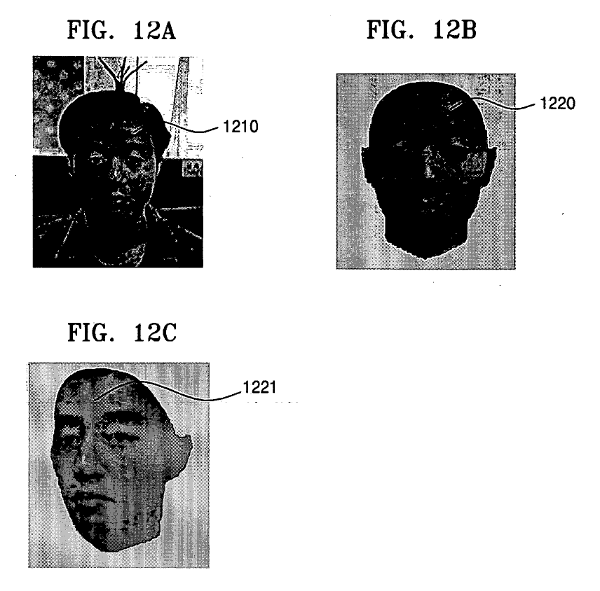

FIGS. 11 and 12 show experimental results obtained by applying an embodiment of the present invention. Referring to FIG. 11, 3D shapes 1120 and 1121 created according to an embodiment of the present invention are very similar to a given 2D image 1110. Referring to FIG. 12, 3D shapes 1220 and 1221 created according to an embodiment of the present invention are very similar to a given 2D image 1210.

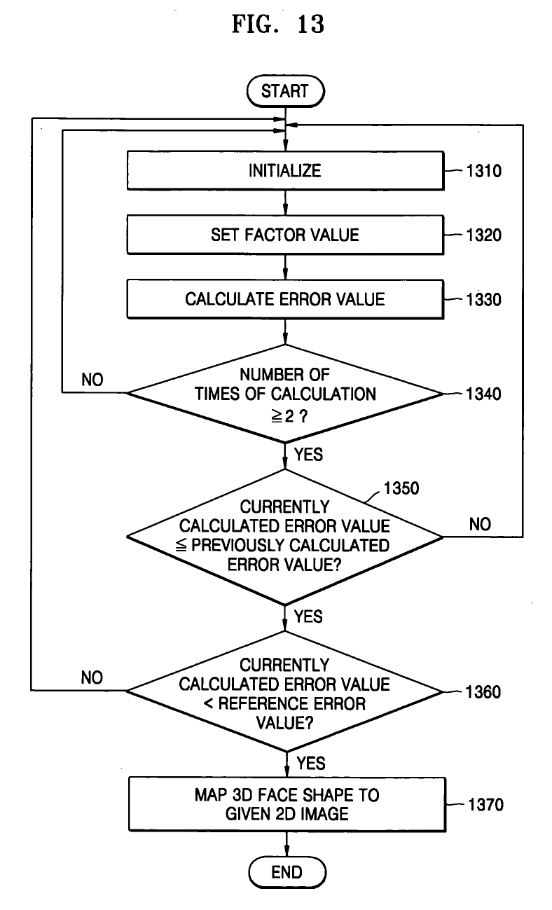

FIG. 13 is a flowchart illustrating a method of creating a 3D shape according to an embodiment of the present invention. The method includes setting a factor value and calculating an error value (operations 1310 through 1330), determining whether to perform mapping according to a calculated error value (operations 1340 through 1360), and performing mapping (operation 1370). Hereafter, the method is explained in conjunction with the apparatus of FIG. 2 for ease of explanation only.

The control unit 214 initializes all factor values (operation 1310). After operation 1310, the control unit 214 instructs the factor value setting unit 212 to operate and the factor value setting unit 212 sets a factor value accordingly (operation 1320).

After operation 1320, the error value calculating unit 218 calculates an error value F (operation 1330) and transmits the calculated error value to the control unit 214. The control unit 214, which receives the error value, determines whether the error value calculating unit 218 calculated the error value more than twice (operation 1340).

In operation 1340, if the control unit 214 determines that the error value calculating unit 218 calculated the error value once, operation 1310 is performed. If the control unit 214 determines that the error value calculating unit 218 calculated the error value more than twice, the control unit 214 compares a current error value and a previous error value calculated by the error value calculating unit 218 (operation 1350).

As a result of comparison in operation 1350, if the current error value is greater than the previous error value, operation 1310 is performed. Conversely, if the current error value is smaller than the previous value, the control unit 214 determines whether the current error value calculated by the error value calculating unit 218 is smaller than a reference value (operation 1360).

In operation 1360, if the control unit 214 determines that the current error value is greater than the reference value, operation 1310 is performed. Conversely, if the control unit 214 determines that the current error value is smaller than the reference value, the mapping unit 222 creates a 3D shape of a given 2D image (operation 1370).

As described above, according to an apparatus and method of creating a 3D shape and a computer-readable recording medium storing a computer program for executing the method according to embodiments of the present invention, even when a single 2D image is given, a 3D shape of the 2D image can be accurately estimated.

According to an apparatus and method of creating a 3D shape and a computer-readable recording medium storing a computer program for executing the method according to embodiments of the present invention, even when feature points of a given 2D image are not accurately detected using the ASM algorithm, a 3D shape of the 2D image can be accurately estimated. Thus, a 3D shape that can always be recognized as a human face can be created.

Further, according to an apparatus and method of creating a 3D shape and a computer-readable recording medium storing a computer program for executing the method according to embodiments of the present invention, a 3D shape of a given 2D image can be quickly created.

Embodiments of the present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for creating a three-dimensional shape, comprising:
a factor value setting unit setting factor values including a weight, a mapping factor, and a focal distance, for each of a plurality of stored three-dimensional models;
an error value calculating unit calculating an error value as a function of the factor value, the error value comprising a value of an extent of a difference between a first estimated shape and a second estimated shape;
a control unit comparing the calculated error value with a preset reference value and outputting the result of comparison as a control signal; and
a mapping unit weighing target weights to the stored three-dimensional models in response to the control signal, adding the stored three-dimensional models having the weighed target weights, and creating a three-dimensional shape of a given two-dimensional image,
wherein the mapping factor maps a two-dimensional variable to a three-dimensional variable, the first estimated shape is created by adding the stored three-dimensional models having set weights, the second estimated shape is created by mapping the two-dimensional image using the mapping factor, and the target weight is a weight having the calculated error value smaller than the preset reference value, among the set weights.

2. The apparatus of claim 1, wherein the error value further comprises a value of an extent to which the first estimated shape deviates from a predetermined three-dimensional model.

3. The apparatus of claim 1, wherein the first estimated shape is created by adding a shape created by adding the stored three-dimensional models having the set weights and an average shape of the stored three-dimensional models, the error value further comprises a value proportional to a total sum of the set weights, and the mapping unit weighs the target weights to the stored three-dimensional models in response to the control signal, adds the stored three-dimensional models having the weighed target weights and the average shape of the stored three-dimensional models, and creates the three-dimensional shape of the given two-dimensional image.

4. The apparatus of claim 1, wherein the control unit instructs the factor value setting unit to reset factor values when the calculated error value is greater than the preset reference value.

5. The apparatus of claim 4, wherein the factor value setting unit sets the factor value greater than a previous factor value by a first predetermined value, sets the factor value greater than the previous factor value by a second predetermined value when receiving an instruction from the control unit to reset factor values, and the first predetermined value is greater than the second predetermined value.

6. The apparatus of claim 1, further comprising a basic model storage unit storing the three-dimensional models.

7. The apparatus of claim 1, further comprising a user interface unit providing an interface by which the factor value can be input and transmitting the input factor value to the factor value setting unit.

8. The apparatus of claim 1, wherein the given two-dimensional image is generated by photographing, and the second estimated shape is calculated by
Xₒᵢ^{t}=−(xᵢ₋Δx^{t-1})(Zₒᵢ^{t-1}−T_{z}^{t-1})/ƒ^{t-1}+Tₓ^{t-1} (1)
Yₒᵢ^{t}=−(yᵢ₋Δy^{t-1})(Zₒᵢ^{t-1}−T_{z}^{t-1})/ƒ^{t-1}+T_{y}^{t-1} (2)
Zₒᵢ^{t}=Zₒᵢ^{t-1} (3),
wherein o denotes the second estimated shape, x and y denote two-dimensional position information of each portion of the given two-dimensional image, i denotes a unique number of the each portion having the two-dimensional position information or a unique number of each of mapped portions of the second estimate shape, X, Y and Z denote three-dimensional position information of each portion of the second estimated shape, Tₓ, T_{y} or T_{z} is one of mapping factors and variable constant, Δx and Δy are factors that change position information of the given two-dimensional image, f, which is one of mapping factors, denotes a focal distance of a photographing device that obtains the given two-dimensional image, t denotes a factor t-th set by the factor value setting unit when t is used as a subscript of the factor, and t denotes the second estimated shape created using the t-th set factor when t is used as a subscript of the three-dimensional position information.

9. The apparatus of claim 1, wherein a number of the stored three-dimensional models is n, and the first estimated shape is calculated by
$$\begin{matrix}{X}_{e}^{t} = {X}_{avg} + {\sum }_{j = 1}^{n} {α}_{j} {σ}_{j} {X}_{j} , & ( 4 ) \\ {Y}_{e}^{t} = {Y}_{avg} + {\sum }_{j = 1}^{n} {α}_{j} {σ}_{j} {Y}_{j} , & ( 5 ) \\ {Z}_{e}^{t} = {Z}_{avg} + {\sum }_{j = 1}^{n} {α}_{j} {σ}_{j} {Z}_{j} , and & ( 6 )\end{matrix}$$
wherein e denotes the first estimated shape, X, Y and Z denote three-dimensional position information of each portion of the first estimated shape, X_{avg}, Y_{avg} and Z_{avg} denote position information of each portion of the average shape of the n stored three-dimensional models, t denotes the first estimated shape created using a weight t-th set by the factor value setting unit, j denotes a unique number of each of the n stored three-dimensional models, α denotes the weight, Xⱼ, Yⱼ and Zⱼ denote three-dimensional position information of each portion of each of the n stored three-dimensional models, and σ is a variable constant and set for each of the n stored three-dimensional models.

10. The apparatus of claim 1, wherein the error value is calculated by
$$\begin{matrix}F = {E}_{0} + {E}_{c} , & ( 7 ) \\ {E}_{O} = {E}_{d} / {s}^{2} , & ( 8 ) \\ {E}_{d} = {\sum }_{j = 1}^{n} ( {\sum }_{i = 1}^{m} {( {X}_{oi}^{t} - {X}_{ei}^{t} )}^{2} + {\sum }_{i = 1}^{m} {( {Y}_{oi}^{t} - {Y}_{ei}^{t} )}^{2} + {\sum }_{i = 1}^{m} {( {Z}_{oi}^{t} - {Z}_{ei}^{t} )}^{2} ) , & ( 9 ) \\ s = {P}_{o} / {P}_{avg} , & ( 10 ) \\ {E}_{c} = λ {\sum }_{j = 1}^{n} {α}_{j}^{2} , and & ( 11 )\end{matrix}$$
wherein F denotes the error value calculated by the error value calculating unit, Eₒ denotes a value of an extent of a difference between the first estimated shape and the second estimated shape, E_{c} denotes the value of the extent to which the first estimated shape deviates from the average shape of the n stored three-dimensional models, e denotes the first estimated shape, o denotes the second estimated shape, oi denotes the unique number of each of the mapped portions of the second estimated shape, ei denotes a unique number of a portion of the first estimated shape having relative position information in the first estimated shape, which is identical to the relative position information, in the second estimated shape, of a portion of the second estimated shape having oi, m denotes a number of i, j denotes the unique number of each of the n stored three-dimensional models, Xₒ, Yₒ and Zₒ denote the three-dimensional position information of each portion of the second estimated shape, Xₑ, Yₑ and Zₑ denote the three-dimensional position information of each portion of the first estimated shape, which corresponds to the position information of each of Xₒ, Yₒ and Zₒ, s denotes a scale factor, Pₒ denotes a size of an image of the second estimated shape projected onto a predetermined surface, P_{avg} denotes a size of an image of the average shape of the n stored three-dimensional models projected onto the predetermined surface, α denotes the weight, and λ is a proportional factor set in advance.

11. A method of creating a three-dimensional shape, comprising:
setting a factor value, which comprises a weight, a mapping factor, and a focal distance, for each of a plurality of stored three-dimensional models;
calculating an error value as a function of the factor value, the error value comprising a value of an extent of a difference between a first estimated shape and a second estimated shape, according to the factor value;
comparing the calculated error value with a preset reference value; and
weighing the set weight to the stored three-dimensional model when the calculated error value is smaller than the preset reference value, adding the weighted three-dimensional models, and creating a three-dimensional shape of a given two-dimensional image,
wherein the mapping factor maps a two-dimensional variable to a three-dimensional variable, the first estimated shape is created by adding the weighted three-dimensional models, and the second estimated shape is created by mapping the two-dimensional image using the mapping factor.

12. The method of claim 11, wherein the error value further comprises a value of an extent to which the first estimated shape deviates from a predetermined three-dimensional model.

13. The method of claim 11, further comprising changing the factor value to an initial set value set in advance and initializing the factor value.

14. The method of claim 11, wherein the calculating of the error value comprises:
calculating the error value, which is the function of the factor value and comprises the value of the extent to which the first estimated shape deviates from the second estimated shape, according to the set factor value;
determining whether the error value was calculated for the first time; and
performing the setting of the factor value when it is determined that the error value was calculated for the first time.

15. The method of claim 11, wherein the comparing of the calculated error value with the preset reference value comprises comparing the calculated error value with a previously calculated error value and comparing the calculated error value with a preset reference value when the calculated error value is smaller than the previously calculated error value, and in the creating of the three-dimensional shape of the given two-dimensional image, target weights are weighted to the stored three-dimensional models when the calculated error value is smaller than the preset reference value, the weighted three-dimensional models are added, and the three-dimensional shape of the given two-dimensional image is created, and the target weight is a weight having the calculated error value smaller than the preset reference value, among the set weights.

16. The method of claim 14, wherein the comparing of the calculated error value with the preset reference value comprises comparing the calculated error value with the previously calculated error value when the error value was not calculated for the first time and comparing the calculated error value with the preset reference value when the calculated error value is smaller than the previously calculated error value, and in the creating of the three-dimensional shape of the given two-dimensional image, the target weights are weighted to the stored three-dimensional models when the calculated error value is smaller than the preset reference value, the weighted three-dimensional models are added, and the three-dimensional shape of the given two-dimensional image is created, and the target weight is a weight having the calculated error value smaller than the preset reference value, among the set weights.

17. The method of claim 11, wherein the comparing of the calculated error value with the preset reference value comprises comparing the calculated error value with the previously calculated error value and performing the setting of the factor value when the calculated error value is greater than the previously calculated error value.

18. The method of claim 11, further comprising performing the setting of the factor value when the calculated error value is greater than the preset reference value.

19. A computer-readable recording medium storing a computer program for executing a method of creating a three-dimensional shape, the method comprising:
setting a factor value, which comprises a weight, a mapping factor, and a focal distance, for each of a plurality of stored three-dimensional models;
calculating an error value as a function of the factor value, the error value comprising a value of an extent of a difference between a first estimated shape and a second estimated shape, according to the factor value;
comparing the calculated error value with a preset reference value; and
weighing the set weight to the stored three-dimensional model when the calculated error value is smaller than the preset reference value, adding the weighted three-dimensional models, and creating a three-dimensional shape of a given two-dimensional image,
wherein the mapping factor maps a two-dimensional variable to a three-dimensional variable, the first estimated shape is created by adding the weighted three-dimensional models, and the second estimated shape is created by mapping the two-dimensional image using the mapping factor.
